(19) United States
(12) Patent Application Publication
(10) Pub. No.: US 2014/0246943 A1
(43) Pub. Date: Sep. 4, 2014

(54) OPTIMUM ROTOR SKEW ANGLE FOR AN ELECTRIC MACHINE

(71) Applicant: GM GLOBAL TECHNOLOGY OPERATIONS LLC, Detroit, MI (US)

(72) Inventors: Avoki M. Omekanda, Rochester, MI (US); John C. Morgante, Sterling Heights, MI (US)

(73) Assignee: GM GLOBAL TECHNOLOGY OPERATIONS LLC, Detroit, MI (US)

(21) Appl. No.: 13/782,320

(22) Filed: Mar. 1, 2013

(51) Int. Cl. H02K 17/16; B60L 1/00

(52) U.S. Cl. CPC H02K 17/165; B60L 1/00
USPC 310/211; 307/10.1

(57) ABSTRACT

An electric machine includes a stator core defining a number of stator slots (S) extending along a longitudinal axis and angularly spaced about the longitudinal axis. The machine includes a rotor assembly rotatable relative to the stator core and defining first and second ends. The rotor assembly includes a plurality of laminations stacked between the first and second ends. Each respective one of the plurality of laminations defines a number of rotor slots (R) positioned along an outer periphery. A stator slot pitch is defined as 360 divided by the number of stator slots (S). A rotor slot pitch is defined as 360 divided by the number of rotor slots (R) in each respective one of the plurality of laminations. The laminations are skewed relative to each other. An optimal rotor skew angle is determined by the greater of the stator slot pitch and rotor slot pitch.

### TECHNICAL FIELD

The present invention relates generally to an electric machine, and more particularly, to an optimal configuration for the rotor assembly in the electric machine.

### BACKGROUND

An electric machine generally includes a rotor assembly that is rotatable relative to a stator assembly. To reduce torque ripple and cogging torque, the rotor or stator assemblies may be skewed. Different skew angles have different effects on the maximum torque, minimum torque and average torque produced by a particular electric machine. The optimal skew angle for reducing torque ripple in a particular machine is not obvious.

### SUMMARY

An electric machine includes a stator core defining a number of stator slots (S) extending along a longitudinal axis and angularly spaced about the longitudinal axis. The machine includes a rotor assembly rotatable relative to the stator core and defining a first and a second end. The rotor assembly includes a plurality of laminations stacked between the first and second ends. Each respective one of the plurality of laminations defines a number of rotor slots (R) positioned along an outer periphery. A stator slot pitch is defined as 360 divided by the number of stator slots (S). A rotor slot pitch is defined as 360 divided by the number of rotor slots (R) in each lamination (all the laminations have the same number of rotor slots (R)). The laminations skewed relative to each other. An optimal rotor skew angle is determined by the greater of the stator slot pitch and the rotor slot pitch. This optimal rotor skew angle results in the optimal reduction of torque ripple for the electric machine, resulting in reduced acoustic noise and vibration.

Each of the number of rotor slots may be configured to receive a respective rotor bar. The laminations are skewed relative to each other such that an angular position of the respective rotor bar is different at the first end of the rotor assembly relative to the second end of the rotor assembly. In other words, the optimal rotor skew angle is defined as an angle between a first line parallel to the respective rotor bar and a second line parallel to the longitudinal axis.

In one example, the number of stator slots (S) is 72 such that the stator slot pitch is 5 and the number of rotor slots (R) is 56 such that the rotor slot pitch is 6.43. In this case, the optimal rotor skew angle 60 is approximately 6.43 degrees. In another example, the number of stator slots (S) is 72 such that the stator slot pitch is 5 and the number of rotor slots (R) is 60 such that the rotor slot pitch is 6. In this case, the optimal rotor skew angle 60 is approximately 6 degrees. The electric machine may include any number of stator slots (S) and rotor slots (R). In one example, the number of stator slots (S) is between approximately 20 and 120. In one example, the number of rotor slots (R) is between approximately 20 and 120.

A vehicle is disclosed with an engine configured to generate an engine torque and an electric machine operatively connected to the engine. The vehicle may include a pulley unit, for operatively connecting the electric machine to the engine, and a battery array. An inverter is configured to convert a first direct current energy produced by the battery array into alternating current energy for input to the electric machine. A secondary battery may be configured to produce a second direct current energy lower than the first direct current energy. The vehicle may include a vehicle accessory operatively connected to and driven by the battery array. A converter is operatively connected to the vehicle accessory and the battery array. The converter is configured to reduce the first direct current energy produced by the battery array.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle having an electric machine and an engine;

FIG. 2 is a schematic fragmentary plan view of the electric machine having a rotor assembly and shaft;

FIG. 3 is a schematic fragmentary sectional view of the electric machine; and

FIG. 4 is a schematic fragmentary perspective view of the rotor assembly and shaft of the electric machine.

### DETAILED DESCRIPTION

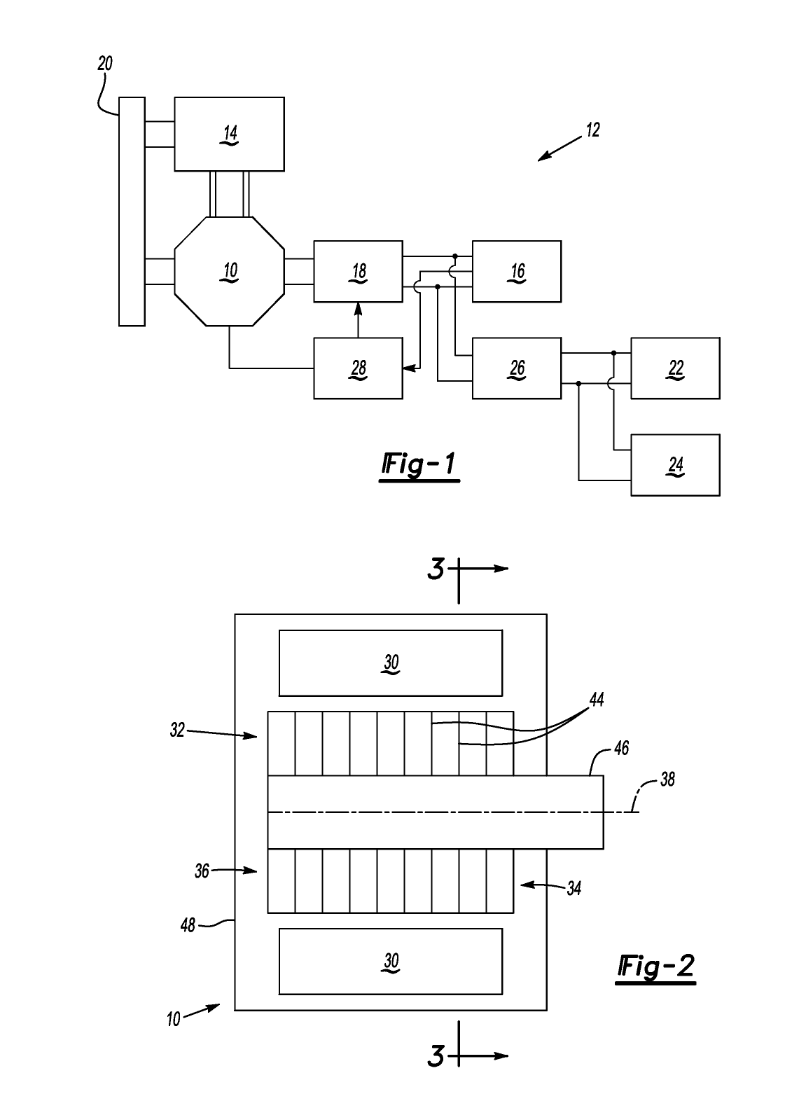

Referring to the Figures, wherein like reference numbers refer to the same or similar components throughout the several views, FIG. 1 is a schematic diagram of a vehicle 12 having an electric motor/generator or electric traction machine, referred to herein as electric machine 10. The vehicle 12 may take many different forms and include multiple and/or alternate components and facilities. While an example vehicle 12 is shown in the Figures, the components illustrated in the Figures are not intended to be limiting. Indeed, additional or alternative components and/or implementations may be used. The electric machine 10 may include any device configured to generate an electric machine torque by, for example, converting electrical energy into rotational motion or vice-versa. The electric machine 10 may be an induction or asynchronous alternating current machine where power is supplied to the rotor with electromagnetic induction, as opposed to commutator or slip rings.

Referring to FIG. 1, the vehicle 12 includes an engine 14 operatively connected to the electric machine 10. The engine 14 may include any device configured to generate an engine torque by, for example, converting a fuel into rotational motion. Accordingly, the engine 14 may be an internal combustion engine configured to convert energy from a fossil fuel into rotational motion using a thermodynamic cycle.

Referring to FIG. 1, the electric machine 10 may be configured to receive electrical energy from a battery array 16. The battery array 16 is configured to store and produce direct current (DC) energy. An inverter 18 is configured to convert the DC energy from the battery array 16 into alternating current (AC) energy for input to the electric machine 10. The electric machine 10 is configured to use the AC energy from the inverter 18 to generate rotational motion. The electric machine 10 may be further configured to generate electrical energy when provided with a torque, such as the engine torque. The battery array 16 is configured to be a high voltage source of power. In one example, the battery array 16 includes a 115 Volt lithium ion battery. In another example, the battery array 16 operates between approximately 42 and 45 Volts.

Referring to FIG. 1, the electric machine 10 may contribute power to the engine 14 via a pulley or belt unit 20. The electric machine 10 allows the addition of some hybrid capabilities to the vehicle 12, such as propelling the vehicle 12 from a dead stop as well as some levels of regenerative braking For example, the engine 14 may shut off at extended stops, such as long stoplights. The electric machine 10, using the belt unit 20, may turn the engine 14 and drive the vehicle 12 until the engine 14 restarts. In one non-limiting example, the machine 10 is a 15 kW or 20 horsepower motor-generator that delivers 79 lb·ft (107 N·m) of torque. The machine 10 may apply that power, through the belt unit 20, not only to propel the vehicle 12 from a dead stop, but also to give the engine 14 extra power for passing or merging.

Referring to FIG. 1, the vehicle 10 may include a secondary battery 22 to power vehicle accessories 24 and other vehicle components. In one example, the secondary battery 22 operates at 14 Volts. Referring to FIG. 1, the vehicle 12 may include a converter 26 (such as a DC-to-DC converter) operatively connected to the accessories 24. The converter 26 includes electronic circuitry that converts a source of direct current (DC) from one voltage level to another. The converter 26 reduces the voltage delivered by the battery array 16, allowing the accessories 24 to be powered by the battery array 16. A controller 28 is operatively connected to the electric machine 10 and configured to control or direct operations of the vehicle 12. The controller 28 may be a hybrid controller that is capable of generating both continuous and discrete control signals based on continuous-time and discrete event dynamics.

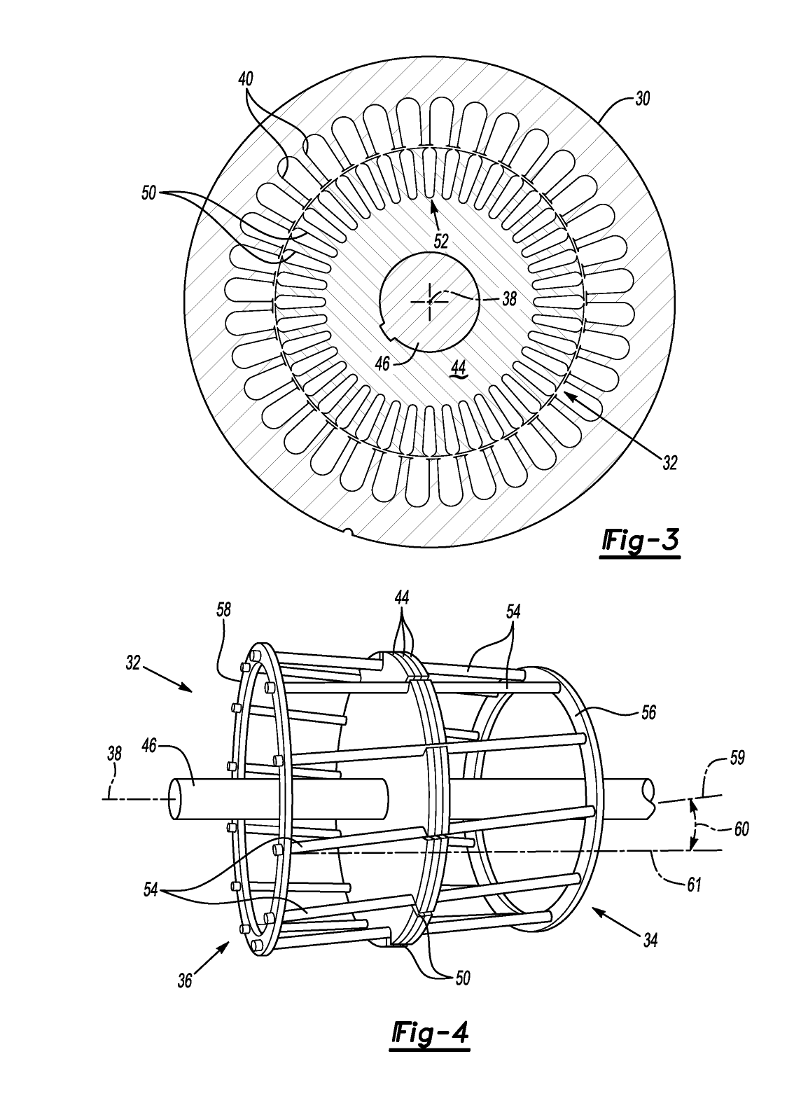

Referring now to FIG. 2, a schematic plan view of the electric machine 10 is shown. FIG. 3 is a schematic fragmentary sectional view of the electric machine 10. Referring to FIGS. 2-3, the electric machine 10 includes a stator core 30 and a rotor assembly 32. Referring to FIGS. 2-3, the rotor assembly 32 is rotatable relative to the stator core 30. Referring to FIG. 2, the rotor assembly 32 defines a first end 34 and a second end 36. Referring to FIGS. 2-3, the rotor assembly 32 may be positioned at least partially within the stator core 30 about a longitudinal axis 38.

Referring to FIG. 3, the stator core 30 defines a plurality of stator slots 40 extending lengthwise along the longitudinal axis 38 (extending out of the page in FIG. 3) and angularly spaced about the longitudinal axis 38. The number of stator slots 40 in the stator core 30 is referred to herein as “S.” Referring to FIG. 3, the stator slots 40 may be evenly spaced from each other radially about the longitudinal axis 38. Stator coils or windings (not shown) may be positioned in each of the stator slots 40.

FIG. 4 is a schematic fragmentary perspective view of the rotor assembly 32. Referring to FIGS. 2 and 4, the rotor assembly 32 includes a plurality of laminations 44 stacked between the first and second ends 34, 36. For clarity, only a few laminations 44 are shown in FIG. 4. Referring to FIGS. 2-4, the laminations 44 may be positioned around a shaft 46. In one example, the laminations 44 are circular disks which are made of flat sheets of silicon steel. The sheets, which may be made of other suitable materials, are fitted into a punching die (not shown) which punches holes into the sheet resulting in a generally ring-like shape. Other suitable non-circular shapes may also be employed. Referring to FIG. 2, the machine 10 may include a housing 48 for supporting the rotor assembly 32 and stator core 30.

Referring to FIG. 3, each lamination 44 defines a number of rotor slots 50 positioned along an outer periphery 52. The number of rotor slots 50 in each lamination 44 is referred to herein as “R.” Each lamination 44 has the same number (R) of rotor slots 50. Referring to FIG. 4, conducting bars 54, referred to herein as rotor bars 54, may be positioned in each of the rotor slots 50. Each rotor slot 50 is configured to receive one of the rotor bars 54. The rotor bars 54 may be composed of any suitable conducting material, including but not limited to, copper, aluminum, brass etc. Alternatively, windings or coils (not shown) may be placed in the rotor slots 50.

Referring to FIG. 4, the rotor bars 54 may be physically and electrically joined together at each of the first and second ends 34, 36, of the rotor assembly 32 by conducting first and second end rings 56, 58, respectively. The rotor bars 54 may be formed by casting methods. In one example, molten aluminum or other suitable material is injected into the rotor slots 50. The molten aluminum flows through the rotor slots 50 from the first end 34 to the second end 36 of the rotor assembly 32. A source of pressure, such as hydraulic back pressure, may be applied against the molten metal in order to lock the laminations 44 together in a unitary configuration, thereby avoiding air gaps, porosity and bubbles. The molten aluminum solidifies to create the rotor bars 54 and the first and second end rings 56, 58. The first and second end rings 56, 58 serve to enhance the conductivity of the rotor assembly 32. Other suitable methods may be employed.

The operation of the electric machine 10 depends on the interaction between two magnetic fields. In the case where the electric machine 10 is an induction motor, these magnetic fields result from current flowing in the stator windings (not shown) and in the rotor bars 54. The current in the stator windings produce a rotating magnetic field which sweeps past the rotor bars 54 and induces an electromotive force in them. As a result, an induced current flows in the rotor bars 54 and first and second end rings 56, 58. The induced current in the rotor assembly 32 establishes its own magnetic field, which interacts with the magnetic field of the stator core 30. This produces a force and hence causes the rotor assembly 32 to turn in the same direction as the magnetic field of the stator core 30.

Referring to FIG. 4, the laminations 44 are skewed relative to each other such that an angular position of a rotor bar 54 is different at the first end 34 of the rotor assembly 32 relative to the angular position of that rotor bar 54 at the second end 36 of the rotor assembly 32. Referring to FIG. 4, the rotor skew angle 60 is defined by the angle subtended by a first line 59 that is parallel to a rotor bar 54 and a second line 61 that is parallel to the longitudinal axis 38. The laminations 44 may be skewed prior to the casting of the rotor bars 54 (described above). Different skew angles have different effects on the maximum torque, minimum torque and average torque produced by the electric machine 10. The precise skew angle that would optimally reduce torque ripple is not an obvious determination.

The electric machine 10 defines an optimal rotor skew angle 60 that optimally reduces undesirable torque ripple, reducing unwanted vibration and noise. The optimal rotor skew angle 60 is determined by the greater of a stator slot pitch and a rotor slot pitch, that is, whichever is greater between the stator slot pitch and the rotor slot pitch. The stator slot pitch is defined as 360 divided by the number of stator slots 40 (S). The rotor slot pitch is defined as 360 divided by the number of rotor slots 50 (R) in each lamination 44 (each lamination 44 has the same number of rotor slots 50). Stated differently:

$$Optimal Rotor Skew Angle = maximum ( \frac{360}{S} , \frac{360}{R} )$$

In one example, the number of stator slots (S) is 72 such that the stator slot pitch is 5 and the number of rotor slots (R) is 56 such that the rotor slot pitch is approximately 6.43. In this case, the optimal rotor skew angle 60 is approximately 6.43 degrees. In another example, the number of stator slots (S) is 72 such that the stator slot pitch is 5 and the number of rotor slots (R) is 60 such that the rotor slot pitch is 6. In this case, the optimal rotor skew angle 60 is approximately 6 degrees. The electric machine 10 may include any number of stator slots 40 (S) and rotor slots 50 (R). In one example, the number of stator slots 40 (S) is between approximately 20 and 120. In one example, the number of rotor slots 50 (R) is between approximately 20 and 120.

In another example, the number of stator slots 40 (S) is 40 such that the stator slot pitch is 9 and the number of rotor slots 50 (R) is 56 such that the rotor slot pitch is approximately 6.43. In this case, the optimal rotor skew angle 60 is approximately 9 degrees. In another example, the number of stator slots 40 (S) is 84 such that the stator slot pitch is approximately 4.29 and the number of rotor slots 50 (R) is 52 such that the rotor slot pitch is approximately 6.92. In this case, the optimal rotor skew angle 60 is approximately 6.92 degrees.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An electric machine comprising:
a stator core defining a number of stator slots (S) extending along a longitudinal axis and angularly spaced about the longitudinal axis;
a rotor assembly rotatable relative to the stator core and defining a first and a second end, the rotor assembly including a plurality of laminations stacked between the first and second ends;
wherein each respective one of the plurality of laminations defines a number of rotor slots (R) positioned along an outer periphery;
wherein a stator slot pitch is defined as 360 divided by the number of stator slots (S);
wherein a rotor slot pitch is defined as 360 divided by the number of rotor slots (R) in the each respective one of the plurality of laminations;
wherein the plurality of laminations are skewed relative to each other; and
an optimal rotor skew angle is determined by the greater of the stator slot pitch and the rotor slot pitch.

2. The machine of claim 1, wherein:
each of the number of rotor slots is configured to receive a respective rotor bar; and
the optimal rotor skew angle is defined between a first line parallel to the respective rotor bar and a second line parallel to the longitudinal axis.

3. The machine of claim 1, wherein:
the number of stator slots (S) is 72 such that the stator slot pitch is 5;
the number of rotor slots (R) is 56 such that the rotor slot pitch is 6.43; and
the rotor skew angle is approximately 6.43 degrees.

4. The machine of claim 1, wherein the number of stator slots (S) is between approximately 20 and 120.

5. The machine of claim 1, wherein the number of rotor slots (R) is between approximately 20 and 120.

6. The machine of claim 1, wherein:
the number of stator slots (S) is 72 such that the stator slot pitch is 5;
the number of rotor slots (R) is 60 such that the rotor slot pitch is 6; and
the rotor skew angle is approximately 6 degrees.

7. The machine of claim 1, wherein:
the number of stator slots (S) is 40 such that the stator slot pitch is 9;
the number of rotor slots (R) is 56 such that the rotor slot pitch is 6.43; and
the rotor skew angle is approximately 9 degrees.

8. The machine of claim 1, wherein:
the number of stator slots (S) is 84 such that the stator slot pitch is 4.29;
the number of rotor slots (R) is 52 such that the rotor slot pitch is 6.92; and
the rotor skew angle is approximately 6.92 degrees.

9. A vehicle comprising:
an engine configured to generate an engine torque;
an electric machine operatively connected to the engine;
a pulley unit for operatively connecting the electric machine to the engine;
a battery array configured to store and produce direct current energy;
an inverter configured to convert the direct current energy from the battery array into alternating current energy for input to the electric machine; and
wherein the electric machine includes:
a stator core defining a number of stator slots (S) extending along a longitudinal axis and angularly spaced about the longitudinal axis;
a rotor assembly rotatable relative to the stator core and defining a first and a second end, the rotor assembly including a plurality of laminations stacked between the first and second ends;
wherein each respective one of the plurality of laminations defines a number of rotor slots (R) positioned along an outer periphery;
wherein a stator slot pitch is defined as 360 divided by the number of stator slots (S);
wherein a rotor slot pitch is defined as 360 divided by the number of rotor slots (R) in the each respective one of the plurality of laminations;
wherein each of the number of rotor slots is configured to receive a respective rotor bar;
the plurality of laminations are skewed relative to each other such that an angular position of the respective rotor bar is different at the first end of the rotor assembly relative to the second end of the rotor assembly; and
wherein an optimal rotor skew angle is determined by the greater of the stator slot pitch and the rotor slot pitch.

10. The vehicle of claim 9, further comprising:
a secondary battery configured to produce a second direct voltage, the second direct voltage being lower than the first direct voltage;
a vehicle accessory operatively connected to and driven by the battery array; and
a converter operatively connected to the vehicle accessory and the battery array, the converter being configured to reduce the first direct voltage produced by the battery array.

11. The vehicle of claim 9, wherein:
the number of stator slots (S) is 72 such that the stator slot pitch is 5;
the number of rotor slots (R) is 56 such that the rotor slot pitch is 6.43; and
the rotor skew angle is approximately 6.43 degrees.

12. The vehicle of claim 9, wherein the number of stator slots (S) is between approximately 20 and 120.

13. The vehicle of claim 9, wherein the number of rotor slots (R) is between approximately 20 and 120.

14. The vehicle of claim 9, wherein:
the number of stator slots (S) is 72 such that the stator slot pitch is 5;
the number of rotor slots (R) is 60 such that the rotor slot pitch is 6; and
the rotor skew angle is approximately 6 degrees.

15. The vehicle of claim 9, wherein:
the number of stator slots (S) is 40 such that the stator slot pitch is 9;
the number of rotor slots (R) is 56 such that the rotor slot pitch is 6.43; and
the rotor skew angle is approximately 9 degrees.

16. The vehicle of claim 9, wherein:
the number of stator slots (S) is 84 such that the stator slot pitch is 4.29;
the number of rotor slots (R) is 52 such that the rotor slot pitch is 6.92; and
the rotor skew angle is approximately 6.92 degrees.

17. A vehicle comprising:
an engine configured to generate an engine torque;
an electric machine operatively connected to the engine;
a pulley unit for operatively connecting the electric machine to the engine;
a battery array configured to store and produce a first direct current energy;
an inverter configured to convert the first direct current energy from the battery array into alternating current energy for input to the electric machine;
a secondary battery configured to produce a second direct current energy, the second direct energy being lower than the first direct current energy;
a vehicle accessory operatively connected to and driven by the battery array;
a converter operatively connected to the vehicle accessory and the battery array, the converter being configured to reduce the first direct current energy produced by the battery array; and
wherein the electric machine includes:
a stator core defining a number of stator slots (S) extending along a longitudinal axis and angularly spaced about the longitudinal axis;
a rotor assembly rotatable relative to the stator core and defining a first and a second end, the rotor assembly including a plurality of laminations stacked between the first and second ends;
wherein each respective one of the plurality of laminations defines a number of rotor slots (R) positioned along an outer periphery;
wherein a stator slot pitch is defined as 360 divided by the number of stator slots (S);
wherein a rotor slot pitch is defined as 360 divided by the number of rotor slots (R) in the each respective one of the plurality of laminations;
wherein the plurality of laminations are skewed relative to each other; and
an optimal rotor skew angle is determined by the greater of the stator slot pitch and the rotor slot pitch.
